(19) United States
(12) Patent Application Publication
(10) Pub. No.: US 2014/0095170 A1
(43) Pub. Date: Apr. 3, 2014

(54) USER PROGRAMMABLE MONITORING SYSTEM, METHOD AND APPARATUS

(71) Applicant: 2220213 Ontario Inc., Ottawa (CA)

(72) Inventors: Michael James Roper, Ottawa (CA); Tavener George Taylor Bremner, Fitzroy Harbor (CA)

(73) Assignee: 2220213 Ontario Inc., Ottawa (CA)

(21) Appl. No.: 14/039,069

(22) Filed: Sep. 27, 2013

Related U.S. Application Data
(60) Provisional application No. 61/708,175, filed on Oct. 1, 2012.

(51) Int. Cl. G08B 3/00

(52) U.S. Cl. CPC G08B 3/00
USPC 704/274

(57) ABSTRACT

A system, method and apparatus monitor sensors or instruments and provide outputs in the form of voice messages. Data output from the sensors may thus be presented to humans without reference to a visual display. The voice messages may either be assembled from a library of recordings in the form of voice message segments or derived from text and then converted to speech. The voice messages may be output through one or more loudspeakers or via a wireless headset, intercom or portable radio. The user can configure the system for use with different types of sensors and data protocols for a wide variety of different applications and use-cases, using a simple graphical user interface. In accordance with one embodiment the system may be implemented on a personal computer or tablet computer. In an alternative embodiment the processing is performed by an embedded processor and a personal or tablet computer is only connected when it is necessary to change the control program.

### CROSS-REFERENCE TO RELATED APPLICATIONS

The present application claims priority to U.S. provisional patent application Ser. No. 61/708,175 filed Oct. 1, 2012. The patent application identified above is incorporated by reference herein in its entirety.

### TECHNICAL FIELD

This invention relates generally to a user programmable system, method and apparatus for monitoring one or more sensors or instruments. Especially, but not exclusively, the present invention relates to a user programmable monitoring system, method and apparatus whereby the output is provided in the form of short voice messages.

### BACKGROUND OF THE INVENTION

There are many instances where one or more humans work to operate or perform maintenance on, or nearby, complex machinery. It is generally desirable to provide the operating or maintenance crew with information regarding the state of the equipment and to alert them to any changes that may affect the performance of the machinery of the safety of the crew. In many cases this information is presented in the form of visual displays, as these can present a large amount of data to the observer; common examples include cockpit and vehicle displays. However this type of display may generally only be observed by one operator/user at a time that must be stationed in front of the display. Where the crew members are required to work in a number of different areas, or are mobile, the use of visual displays is not entirely satisfactory. Examples include crews working with construction equipment, power plant, robotic vehicles, and ships and sailing vessels.

A second limitation regarding the use of a visual display is that it requires the user-operator to look away from any other task at hand to view the display and then to re-focus on the original task. Research performed in a number of fields, including automobile safety, shows that, where head rotation is required as well as saccadic eye movement to locate a new visual target, the time taken is in the range 2-3 seconds. Added to this is the time required to read the display, which, depending on the clarity of the information presented, may be between 1 and 3 seconds. A second head rotation is then required to re-acquire the original visual target, so the loss of visual contact with this original visual target may often exceed 5 seconds, particularly in conditions of low light and poor visibility. Where work is being performed that requires continuous visual observation, this may be unacceptable. For example, in the specific example of a racing sailboat, the crew need information from several different sensors to sail the boat efficiently and safely, but also need to observe their proximity to other boats. In 5 seconds the gap between two boats travelling at just 6 knots may be reduced by more than 100 ft, potentially putting the crew in danger.

When visual observation of a display is not possible or potentially unsafe, it is preferable to present information to the operating or maintenance crew in the form of audible messages. Each application will use a different set of sensors and require a specific set of voice messages tailored for each use-case within the application. At present, the cost of developing such customized voice message systems limits them to high value applications or to certain consumer applications where the cost may be absorbed by the large market size. Examples of such systems are the voice messages used to supplement graphical displays provided in high performance aircraft and vehicular GPS navigation devices.

In the case of some consumer applications the cost of developing a single-use voice messaging system may be justified by the large market size. For example, U.S. Pat. No. 5,799,264, to Mizutani, discloses a GPS based car navigation system that provides voice message outputs in response to particular situations or vehicle locations. The triggers for these messages, and their content, are designed into the device which is thus dedicated to this one, specific application. Similarly, U.S. Pat. No. 8,009,025 to Engstrom, discloses a system for managing multiple applications in a vehicle to reduce the load on the driver by prioritization, including the delivery of voice messages. This device is designed for a single application, i.e., for use in an automobile, and may only be configured by the user to behave differently within that particular application.

Alarm systems, such as those used to protect vehicles and buildings, commonly use a loud audible sound to provide a warning. U.S. Pat. No. 7,893,826, to Strenlund discloses an alarm system which may also provide voice messages to alert the user of alarm conditions. This system adapts to normal conditions and automatically provides outputs when a deviation from normal conditions is encountered but has a limited application.

U.S. Pat. No. 6,192,282 to Smith, discloses a complex system for the control of HVAC equipment which may be programmed for different buildings. To do so, however, requires knowledge of a high level programming or scripting language developed specifically for this system. Acquisition of this knowledge requires some skill and an investment in time which may not be feasible for many smaller industrial or consumer applications.

U.S. Pat. No. 7,898,408, to Russell, discloses a system for remotely monitoring a number of sensors that includes a provision for notification of the sensor status conditions via voice messages. No provision is made in this device for the user to be able to change the voice messages for their particular needs.

Also known are a number of devices which use other types of audible outputs as a means of providing information by non-visual means. For example, marine depth gauges are commonly equipped with a buzzer to warn if the depth is less than a value preset by the user. In U.S. Pat. No. 4,785,404, to Sims, a processor for calculating the “velocity made good” (VMG) in a sailboat is described whereby inputs from a number of sensors are processed to calculate the desired VMG. This apparatus can produce an audible tone whose frequency is in proportion to the VMG, but does not output any voice message. U.S. Pat. No. 7,143,363, to Gaynor also describes a device for processing data from a number of sensors to display the operating conditions of a sailboat. While the visual display may be adapted for different operating conditions, this apparatus still suffers from the limitations of reliance on a visual display described previously.

In summary, while a number of known devices and systems describe the use of sounds and voice messages to relay information derived from sensors, these are designed for a single purpose or application. Presently known commercially available products only find application where a large market size justifies the cost of development of the device.

### SUMMARY OF THE INVENTION

The present invention seeks to eliminate, or at least mitigate, some of the disadvantages of these known prior art products, or at least provide an alternative. To this end the present invention provides a system, method and apparatus for monitoring one or more sensors or instruments in which the output is in the form of user-defined or created voice messages, together with means whereby the system or apparatus may be programmed or configured for widely different applications and use-cases, preferably by the user.

In an aspect there is provided a user programmable monitoring system for providing voice messages based on data input from one or more sensors or instruments comprising; a user interface, which may be a graphical interface, that allows the user to select the input data protocol, construct sets of readings and rules that determine the content and timing of the voice messages, one or more data ports that interface to external sensors or instruments, a processor which parses the sensor data according to the selected protocol to extract the readings and executes the rules to create the voice messages, a scheduler that outputs voice messages in defined time-slots, based on their priority, for driving an audio output device that allows the users to hear the audio messages.

The audio output device may be external or internal to the other parts of the system.

The sensors may be connected by a data bus to an input port or may be individually connected to different ports to provide the interface for the processor. Depending on the application, the sensors may include any combination of voltage, current or power sensors, pressure or depth transducers, temperature and gas monitors, speed, depth, direction or position sensors, or other types of sensor.

The audio output may be connected to a loudspeaker, wireless headset, intercom system, short range or long range radio.

In one implementation the voice messages are assembled from a library of separate voice recordings input or otherwise created by the user via the GUI. Alternatively, the voice messages may be created by a text-to-speech converter.

In a second aspect, there is provided a method of monitoring one of more sensors or instruments that provides notifications in the form of user-defined voice messages comprising; converting the data from different sensors into a form compatible with a digital processor, parsing and processing the sensor data to create a set of readings defined by the user, processing these readings according to a set of logical rules defined by the user and outputting audio messages that provide notifications of the status of the sensor or instrument outputs. The method further comprises providing a means for the user to select the parsing method and to create and edit a set of readings which determine the sensor data to be monitored.

The method may further provide means for the user to create and edit a set of rules for particular applications that determine the content and timing of the voice messages.

The method may further comprise providing means by which the end user is able to create and edit a library of voice recordings for a particular application.

The method may output voice messages composed from a number of sequential voice recordings. Alternatively, the method may comprise creating rule outputs in text form and then converting said text into human speech in a desired language.

In another aspect, there is provided a user programmable monitoring apparatus for providing voice messages based on data input from at least one sensor or instrument, comprising: a user interface, at least one input port which converts data from an external instrument or sensor into a serial data stream, a real-time processor and an audio output device that allows the users to hear the audio messages. Depending on the application, the sensors may include any combination of voltage, current or power sensors, pressure or depth transducers, temperature and gas monitors, speed, depth, direction or position sensors or other types of sensor.

The user interface provides means by which the end user can select a parser and create a set of readings, rules and voice recordings that determine the content and timing of the audio messages. The user interface also includes an input editor, error checking function, a data simulator, and means to create and name audio files. The real-time processor further comprises a CPU, memory storage device, audio decoder and control interfaces which together provide a reading engine which parses the sensor data to extract the readings defined by the user, a rule engine which executes the rules defined by the user to create the voice messages and a scheduler which outputs voice messages in time-slots of fixed duration based on their priority.

In an embodiment, the User Interface is implemented on a personal computer such as a laptop or tablet computer that has adequate resources to support the GUI and a high quality text-to-speech converter. The text-to-speech converter allows the User to create natural sounding audio files by entering the required output in text form. The GUI also includes a file naming utility for the audio files. A lower power CPU and associated electronics, housed in a small separate and environmentally sealed housing, can then be used to generate the audio messages. In this configuration, the PC running the GUI need only be connected to the data processor when it is necessary to change the readings or rules. Voice messages may be constructed from a library of MP3 audio files stored in the CPU memory.

In an alternative embodiment a personal or tablet computer is used to implement the GUI as above and also to process the data and generate audio outputs. In this configuration, an external protocol converter may be connected to the personal computer to convert the sensor or instrument data into a protocol supported by a personal computer, for example Universal Serial Bus (USB). In this configuration, where the computer has sufficient memory and processing resources, a text to speech converter may be used to synthesize voice messages from text strings output by the rule engine.

The foregoing and other objects, features, aspects and advantages of the present invention will become more apparent from the following detailed description, taken in conjunction with the accompanying drawings, of an embodiment of the invention, which description is by way of example only.

### BRIEF DESCRIPTION OF THE DRAWINGS

FIG. 1 is a schematic block schematic diagram of a user programmable monitoring system;

FIG. 2 is a diagram illustrating the data flow through the system;

FIG. 3 is an illustration of a User Interface for programming the system;

FIG. 4 is a timing diagram for the rules and voice messages;

FIGS. 5a, 5b and 5c are diagrams illustrating the syntax of the reading and rule instructions used to program the system;

FIG. 6 is a diagram that provides an example of a rule-set used in the system;

FIG. 7 is a schematic block diagram of the apparatus system partially integrated into a weatherproof housing; and

FIG. 8 illustrates an alternative embodiment of the apparatus based on a personal or tablet computer.

### DETAILED DESCRIPTION

A detailed description of an embodiment of the User Programmable Monitoring System follows and for convenience references the operation of the system where the application is for use in the operation of a sail boat and the different use cases relate to different operating conditions of the boat. It should be understood that this application is used as an example only and embodiments of the invention may used in other types of vessels, or to assist the operation of other types of machines or systems that may be equipped with different types of sensors, as in the examples previously given.

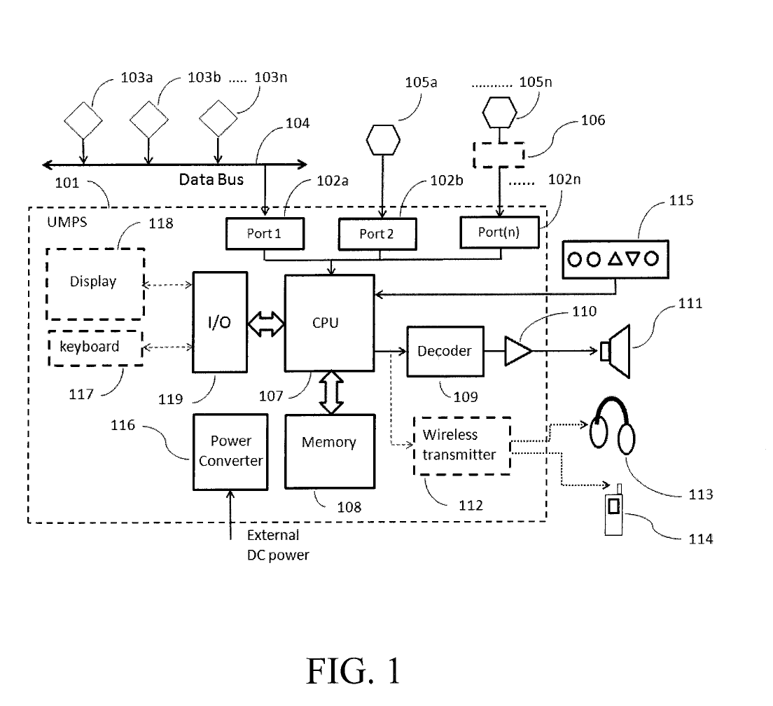

FIG. 1 is a schematic block diagram of a User Programmable Monitoring System (UPMS). The UPMS 101, which comprises the components shown inside the dashed line box, is shown connected to a number of external devices, including sensors 103a . . . 103n and 105a . . . 105n and audio output devices 111, 113 and 114. Many types of sensor are designed for connection to a data bus to reduce the amount of wiring required and in some cases to facilitate communications between sensors, as in the case of NMEA 2000, MODBUS and CANBUS, for example. When connected to a common bus, the sensors output data according to a protocol that allows the sensors to be identified and prevents data collisions. For example in the MODBUS protocol, collisions are avoided because data is only sent from a sensor when a poll request is broadcast with the correct address for that particular sensor. Thus the UPMS 101 includes one or more data ports 102a . . . 102n which connect it to one or more external data buses and associated sensors. As shown, data port 102a is connected to a number of sensors 103a . . . 103n via a common data bus 104, where the data port may transmit poll requests as described above.

The other data ports 102b . . . 102n are shown connected directly to individual sensors 105a . . . 105n. This may be necessary if the sensors 103a . . . 103n interface to a data bus which only allows one data transmitting device to be connected, as in the case of the RS-422 and NMEA 0183 protocols. One or more protocol converters (shown as a dashed box 106) may be used to convert bus formats not supported by the data port to one that is. Examples of sensors that may be connected in the application of UPMS to a boat include a depth gauge, a GPS navigation unit, battery monitors, tank monitors, and wind direction and velocity sensors. Examples of sensors used in industrial applications include electrical sensors (voltage, current, power), position sensors, strain gauges, and pressure, temperature and radiation sensors.

A Central Processing Unit (CPU) 107 samples the sensor or data bus signals arriving on each data port and converts these signals to a binary digital format. The CPU 107 performs the logical operations required to extract the information from this data stream and generate audio outputs, according to a set of readings and rules created by the user as will be described later. An electronic non-volatile memory 108 is used to store the CPU program, including the algorithms required to convert the sensor or data bus signal to a binary digital format, the audio files used by the system, and the readings and rules created by the user.

When the CPU 107 determines that a voice message is to be output it retrieves the required audio files from the memory 108 and forwards them to an audio decoder 109 where they are converted into an analog voice signal. This signal may then be output, via an audio amplifier 110, to one or more external loudspeakers 111, which are located where the user(s) can conveniently hear the message. Alternatively the voice signal can be sent to a wireless transmitter 112 (shown in broken lines), which may be a Bluetooth or Zigbee transmitter, for example, from which it may be transmitted to one or more wireless headsets or headphones 113 used at different locations. Where messages must be relayed over a wide area, as in a mine or industrial complex, the transmitter 112 may be a VHF transmitter which sends the voice message over a longer range wireless link or wide area communications network so that voice messages from one or more UPMS may be received on a remote VHF radio 114.

For normal operation of the UPMS 101a simple control panel 115 is provided to allow the user to start or stop the system, mute or adjust the volume of the audio output, and switch between different sets of rules created by the user. Various components of the system 101 are powered by means of a Power Converter 116, which generates the power needed to operate the system from an external AC or DC source.

The user programs the operation of the system by selecting the data protocol, creating or modifying readings, rules and voice messages. This is done using a keyboard, touchscreen or similar data entry device 117 to modify text information presented to the user on a display 118, both shown in broken lines. These components are not required for the normal operation of the system, and so may be connected via an interface 119 only when it is necessary to re-program it for a different application or use case.

The user can perform the following programming operations to adapt the UPMS to different applications and use cases:

Selection of the message parser for different types of data protocols.

Defining the readings to be obtained from the sensor data.

Defining the logical rules to be applied to the readings.

Loading and naming the audio files used to create the output voice messages.

Programming is simplified by means of a number of features built into the system that allow these operations to be performed without any knowledge of a particular high level or low level programming language.

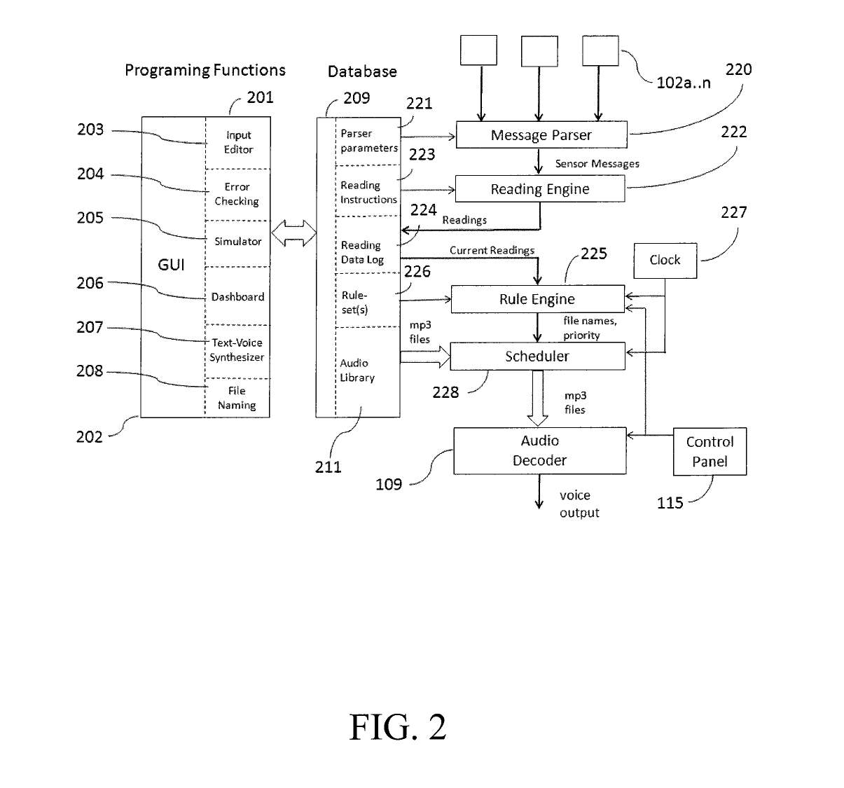

FIG. 2 is a diagram showing data flow through the UPMS and the associated system programming functions 201, which are shown on the left hand side of the diagram. These are described first. A graphical user interface (GUI) 202 is presented on the display for programming the system and incorporating a number of dialog boxes that allow the user to program the system. An input editor 203 is also used to ensure that all user-created data entries are in the correct format. An error checker 204 is also provided that allows the user to verify whether a set of rules contains any syntax or logical errors, such as overlapping conditions. The syntax checker can be run by the user at any time during the creation or editing of rules and readings and runs automatically when data is stored in the database.

A rule-set can also be tested by connecting a simulator 205 to the rule engine, which allows the user to create data inputs with known values without connecting the system to an external sensor or instrument. The simulator 205 may also be used to verify operation of the system by using a test log file containing recorded data an input source. The GUI 202 also includes a dashboard 206 that presents a list of all the readings and their current values, allowing the user to test the operation of a rules-set and verify the accuracy of the audio messages.

The programming functions 201 also include a text-to-speech converter (Text-Voice Synthesizer) 207 that is used to create audio files, whereby the user enters the desired audio output as text and the synthesizer converts the text to a message segment, in the desired language for storage. The message segments are stored in a format such as MP3 which may be easily stored and converted by an audio decoder. The programming functions further include a file naming tool 208 that allows the user to automatically name MP3 audio files with the correct extensions, either individually or in sets. The rules and readings created by the user are stored in a database 209 which is embedded in the system non-volatile memory 108 (see FIG. 1). The audio files created by the user are stored in a dedicated file area 211 in the memory which can be accessed by the audio decoder 109 (see FIG. 1).

The data flow though the UPMS is shown on the right hand side of FIG. 2. The data from the sensors 103a . . . 103n, 105a . . . 105n passes through a series of steps or processes which may be implemented as software algorithms running inside the CPU 107.

The bursts of data output from each sensor and received at each data port 102a . . . 102n are sent to a message parser 220 which extracts individual sensor output messages from the sensor data, based on the properties of the data protocol(s) used by the instruments. For protocols such as MODBUS, where the sensors are located on a common data bus, the message parser 220 may also generate the poll requests, output on data ports 102a . . . 102n, that generate the sensor output messages. For many types of data protocols, the data is encoded in the form of ASCII characters, with special characters used to identify the beginning and end of each sensor message. For example in the NMEA 0183 protocol, each sensor output starts with a particular ASCII character “$” and ends with the characters “CR” “LF” (carriage return and line feed). Other fields in the sensor messages may contain the sensor identifier, status bits, one or more output data samples and error detection bits. These fields may be separated by commas or similar characters to aid parsing of the data. The message parser 220 identifies valid sensor data by recognizing the start and stop characters and performing error detection; any incomplete, un-recognized or erroneous messages are discarded by the message parser. Sets of parser configuration data 221 usually will be stored in the database 209 in the system non-volatile memory 108. The appropriate message parser set is selected by the user to operate with the input data protocol. Data formats not supported by the data ports or available message parsers may be accommodated by using an external protocol converter 106 as shown in FIG. 1.

Valid sensor messages are then forwarded from the message parser 220 to a reading engine 222 which extracts the information required to generate voice messages from the sensor messages in the form of a set of readings. The reading engine is pre-programmed by the user with a number of reading instructions 223 that define the message fields that contain the sensor identification and data for each reading. These instructions are stored in the database 209 after being created by the user and are loaded into the reading engine 222 each time the system 101 is started. The reading engine 222 scans each sensor message and extracts the sensor output values from the defined data field. This data is converted to a floating point reading value with a pre-defined precision, then time-stamped and stored in a readings data log 224. The readings data log is also stored in non-volatile memory 108. Secondary readings may also be derived from this data, such as the reading average, or the deviation from the average or last value. These secondary readings are updated and also stored with each new reading. The reading data log 224 thus provides a permanent record of all readings taken while the system 101 is running and may be retrieved for analysis at a later date.

The timing and content of the audio output messages are determined by one or more logical IF-THEN rules, termed a rule-set 226. The rules are executed by a rule engine 225 that uses the readings as its input, each rule acting on data provided by one reading. In operation, the rule engine 225 is loaded with a single rule-set 226 and executes each rule within the rule-set at time intervals programmed by the user. Provided the conditions do not overlap, multiple rules may be used to process the data from a single reading. Different rule-sets 226 can be programmed into the system by the user to provide voice messages for different use-cases. The rule-sets are also stored in the database 209. In order to reduce processing requirements, each rule is only executed when an output is required. This is determined by configuring each rule to have a specific interval (in seconds) between outputs. An internal clock 227 is used to provide the time reference for the rule engine and a scheduler 228. When a rule is due to be executed, the rule engine retrieves the latest reading data from the reading data log 224 and then executes the rule. If the rule condition is true, the engine outputs the information required to make the corresponding audio announcement to the scheduler 228. In one implementation, this information comprises the names of separate recorded message segments, in the form of MP3 files, which are used to make up the audio message. Alternatively, the output from the rule engine may be in the form of text strings that are forwarded to a text-voice synthesizer.

Creating and storing a separate message for every possible output value from a number of sensors requires a large amount of memory capacity. To reduce memory requirements, each audio message is instead delivered in three separate segments. These are the message header, value and unit. The header includes the words used to describe the message content and is defined by the user in the reading used by the rule. Examples are; “boat speed”, “depth”, “oil pressure”. The value segment contains just the numerical value of the latest reading, for example “fifteen”. The units segment is also defined by the user in the reading and contains the unit of measure, for example “feet” or “kilometers”.

The scheduler 228 retrieves the required message segments from the audio library 211, also stored in the system database 209, and sends them in sequence to the audio decoder 109 (see FIG. 1). The audio decoder output is an analog electrical signal that is sent to an output device (111, 113, 114) and converted to an audible sound. For voice messages where the message segments are stored as separate audio files the audio decoder 109 may be an audio player. The message segments are immediately decoded and output sequentially to form a complete intelligible message, for example “depth fifteen feet”. The audio message segments may be created in different languages, and stored in separate sections of the audio library 211. The UPMS 101 may then be configured to provide the same messages in different languages by directing the scheduler to retrieve the message segments from the appropriate language section in the audio library. Alternatively the message segments may be stored in the form of text strings in which case the audio decoder 109 is a text-to-speech converter. The message segments are converted to speech sequentially and output to form the complete voice message as above, however this implementation requires much greater processing power to provide natural sounding speech.

Data flow through the system is controlled by the user via the external control panel 115 (see FIG. 1). This provides means to select a particular rule set, start and stop a rule-set and adjust the output audio level. The control panel 115 may also be used to control a specialized reading. In a sailboat application, for example, the calculation of a Velocity Made Good (VMG) reading may be based on the boat heading at the instant a button on the control panel is depressed.

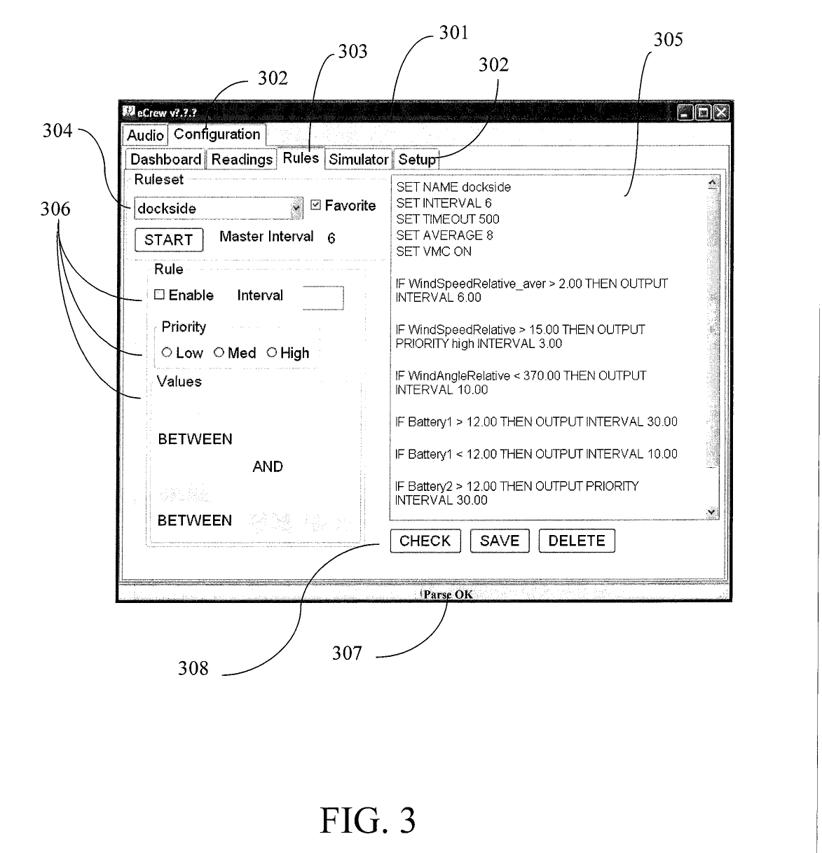

FIG. 3 illustrates an example of a Graphical User Interface (GUI) 202 that provides a simple means for the user to create or edit Rules. The GUI 202 is presented in a window 301 on the display as shown in FIG. 3. The window 301 contains a number of tabs 302 allowing navigation to different sections of the GUI. FIG. 3 shows the GUI with the Rules tab 303, used for creating or editing rule-sets, active, i.e., having been selected. In this tab, a drop down menu 304 is provided to allow the user to select a particular rule-set for editing. The selected rule-set is then presented in a viewing area 305 where it may be viewed and edited by selecting and changing the lines of text. Alternatively, the user may select a particular rule (i.e. by clicking on it) and then change the parameters by means of a set of dialog boxes 306. Any data entry or syntax errors are flagged immediately to the user by the error checker 204 via a message presented on the status bar 307 and are not accepted into the rule until corrected. A number of control buttons 308 allow the user to check the complete rule set for logical errors, save it or delete it. A readings editor, dashboard and other functions are similarly presented under different tabs, selected from one or more menu bars 302.

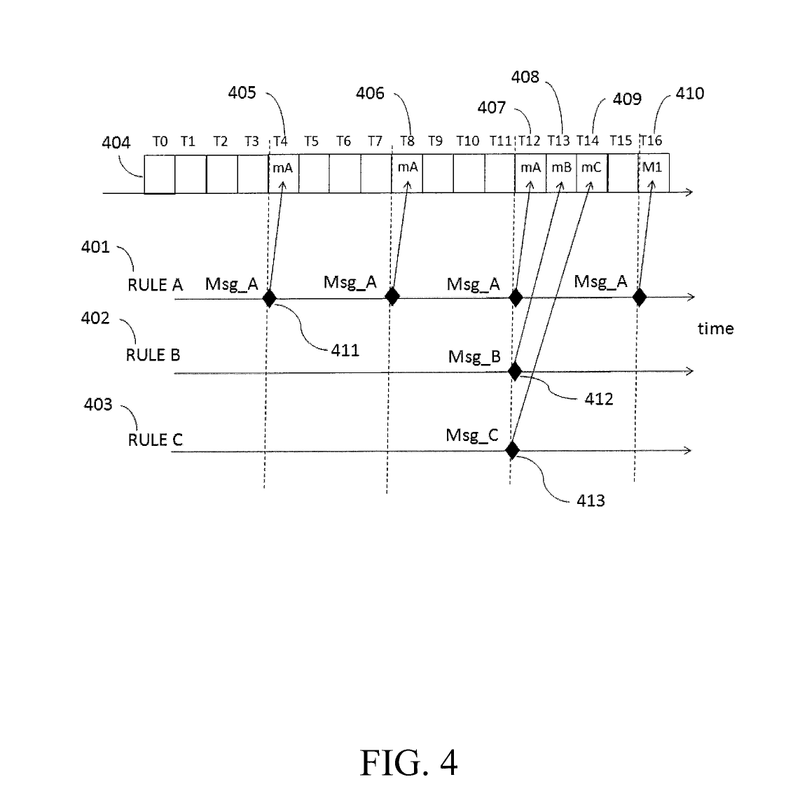

FIG. 4 illustrates the operation of the scheduler 228 (FIG. 2) which is provided to further simplify the programming of the UPMS 101. The scheduler outputs messages in time-slots with a pre-programmed fixed master interval (e.g., 6 seconds), in order to make the output of the system predictable and to prevent any audio messages from overlapping. Only time slots. T0 to T16 are shown in FIG. 4 for convenience. Rules are processed, and the output added to the scheduler message queue at the beginning of the scheduled timeslot. The rule processing time is much smaller than the timeslot duration, so that, if the Rule is true, the voice message can be output in the same timeslot. Messages are queued and then output by the scheduler according to their priority, as follows;

If rule priority=high, the scheduler assigns the message to the current timeslot.

If rule priority=medium, the scheduler assigns the message to the current timeslot only if there are no priority 1 messages in queue; otherwise in the next available timeslot.

If rule priority=low, the scheduler only assigns the message to the current timeslot when there are no higher priority messages to be sent; otherwise in the next available timeslot.

High priority is only assigned to the most important messages, such as those related to safety. These will then always be output immediately by the scheduler. Messages with the same priority may be transmitted in the order in which they arrive at the scheduler. The example of FIG. 4 shows the operation at each priority level. The characteristics of the rules in this example are as follows:

| | |
|---|---|
| Rule A 401 | interval = 4, priority = high, message = Msg_A |
| Rule B 402 | interval = 12, priority = medium, message = Msg_B |
| Rule C 403 | interval = 12, priority = low, message = Msg_C |

Each rule is assumed true when processed and so generates an output message. A series of consecutive timeslots is shown 404, each with a fixed (i.e. 6 second) duration. Rule A 401 is processed in timeslot 405 and the scheduler outputs the message Msg_A 411 in the same timeslot 405. The process is repeated at timeslot 406. At timeslot 407, all three A, B and C rules are processed in parallel. The scheduler outputs the messages from the rules according to their priority level; Rule A 401 message Msg_A 411 (priority high) is output in the current timeslot 407, Rule B message Msg_B 412 is output in timeslot 408 and Rule C message Msg_C 413 is output in timeslot 409. Rule A is processed again and the message Msg_A 411 output by the scheduler in timeslot 410.

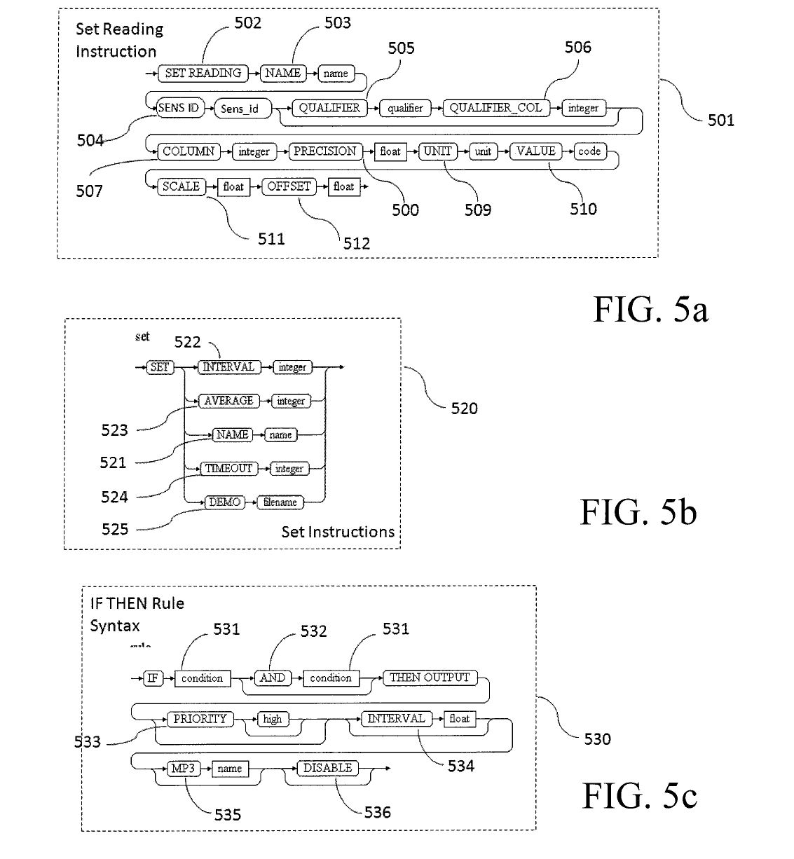

Referring now to FIGS. 5a-5c, FIG. 5a is a diagram showing the syntax of the readings and rules. The SET READING instructions 501 that are used to define each reading are shown inside the dashed box. The parameter names are in upper case text and the values in lower case text. The reading instructions are text strings that can be edited by the user and define the instrument or sensor output to be used in creating voice messages. One set of SET READING instructions is used for all the use cases programmed into the system.

Each reading instruction starts with a SET READING header 502, followed by a unique reading NAME 503 which is specified by the user to identify the reading. The SENS_ID parameter 504 corresponds to the characters used in the serial data protocol to identify the sensor, device or message to be used by the reading. Some reading values may also depend on a value in another column: the optional fields QUALIFIER 505 and QUALIFIER_COL 506 specify this, if necessary. The COLUMN field 507 is the zero-based index of the field containing the value required for the reading. The PRECISION field 500 specifies the precision of the value to be used in processing, in the form of a floating point variable. The UNIT field 509 defines a name for the mp3 file used in the announcement to output the data units, for example “feet” or “volts”. The VALUE field 510 contains a one letter code that is used to specify the set of sound files to be used with the reading. The SCALE field 511 is a multiplier for the reading applied before storing the corresponding value. The value in the OFFSET field 512 is subtracted from the reading, then multiplied by the value in the SCALE field 511 before being stored. If absent from the reading instruction, these parameters default to 1.0 and 0.0 respectively. If a poll based protocol such as MODBUS is used, a simpler reading instruction can be used which simply specifies the reading NAME and the sensor address for the desired reading. The sensor data messages are obtained by broadcasting poll requests sequentially and at a constant rate, each request containing the address information specific to the associated reading instruction.

As described above, the audio output messages are generated by one or more rules (collectively termed a rule-set) that are created by the user and stored in the database 209. A different rule-set is used for each use case and may be selected by the end user using the buttons on control panel 115 while the system is operating. Referring now to FIG. 5b, each rule-set also includes a number of global SET instructions that provide overall control of the rule processing. FIG. 5b shows the syntax of the SET instructions 520 for the rule-set inside the dashed box. SET NAME 521 specifies the name of the rule-set, for example, “Setting Anchor”. SET INTERVAL 522 specifies the duration of the timeslot allocated to each audio output, for example 5 seconds. SET AVERAGE 523 specifies the number of recent readings that are used to calculate an average reading. SET TIMEOUT 524 is an error reporting parameter. If no data is received by the rule processor within the TIMEOUT period, the system reports an error to the user. The SET DEMO instruction 525 specifies the name of the log file containing the simulation data needed to automatically test or demonstrate a rule-set.

FIG. 5c shows the syntax of the logical IF-THEN rules 530 used to generate audio messages. All rules have the same syntax in order to simplify configuration of the system. Each rule is based on a logical test that is applied to a particular reading value, having the form:

IF (condition=TRUE), THEN OUTPUT (audio message)

The output is/are the selected one(s) of the series of audio files used to create the desired message when the rule is true. Only two condition operators 531 are used in the condition test; “<” means “less than”, and “>” [not≧?] means “greater than or equal”. An optional AND operator 532 allows compound rules to be created based on two co-incident conditions. An OR operator is not required as this function can be realized by creating separate rules for each OR condition, each with the same interval, so that they are executed by the scheduler 228 (FIG. 2) at the same time. The reading and rule error checking prevents rules with overlapping conditions from being created.

Each rule may be assigned one of three PRIORITY parameter 533 levels: low, medium or high. The rule INTERVAL 534 specifies how frequently the rule is to be processed. It is a multiple of the master interval. Thus if the instruction SET INTERVAL=5 is used, and the rule specifies INTERVAL 8.0, the rule will be processed at intervals of 5×8.0=40 seconds. As described above, the actual timing of audio announcements is determined by the scheduler 228 and depends on whether the rule is true or not when processed by the rule engine 225, and also the priority level of the rule and other rules that may be queued.

The optional MP3 parameter 535 allows different messages to be created from the same reading, using different audio files in the message header. If no MP3 name 535 is specified, the rule will output the reading name as the filename of the voice message header. The token DISABLE 536 allows a rule to be temporarily turned off without having to delete it from the rule-set.

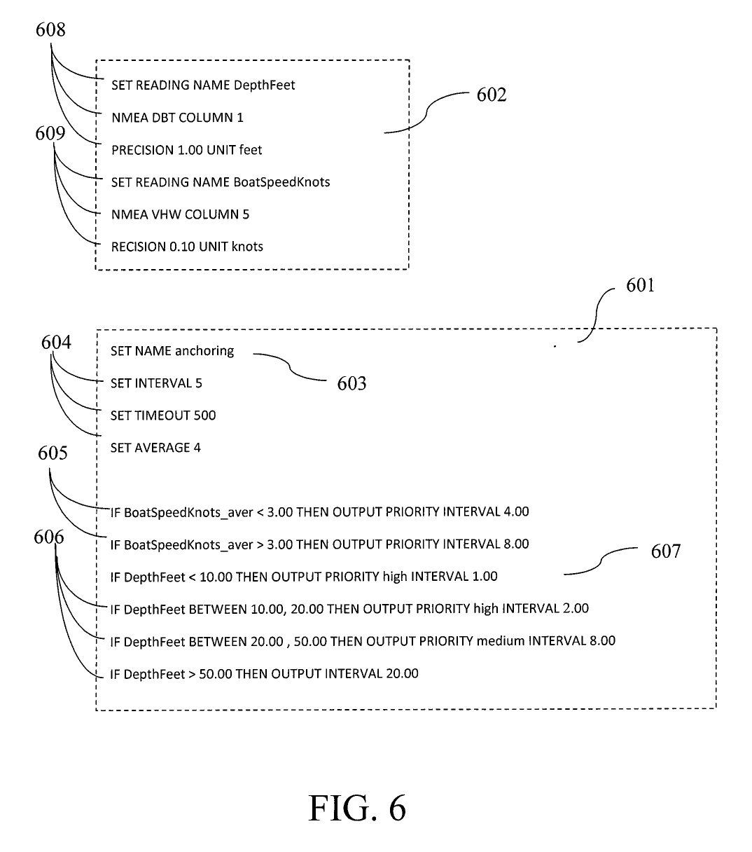

The foregoing example of an application for UPMS 101 is to provide voice messages to the crew of a boat. FIG. 6 is an example of a simple rule-set 601 and the associated readings instructions 602, each shown in a dashed box, used for guiding the crew when a boat is entering an anchorage. This rule-set provides the crew with frequent updates on the depth and the boat speed, so that the anchor may be set at the correct depth and when the boat has just stopped moving. This information is generally not otherwise available to the crew on the bow of the boat where the anchor is located. In FIG. 6 the first SET instruction 603 defines the rule-set name as “anchoring”. The other SET instructions 604 set the master interval to 5 seconds and the timeout and averaging parameters to 500 seconds and 4 readings, respectively. These are followed by a series of rules that output voice messages containing the boat speed 605 and the depth 606. The rules are written such that the frequency of the voice messages “BoatSpeedKnots” and “DepthFeet”, which alert the operator to the vessel speed and depth of water, are increased as the boat speed falls below 3.00 knots and as the depth reduces, i.e. as the boat approaches the anchorage. If the depth falls to less than 10 ft, which may indicate the boat is in danger of running aground, the depth is announced continuously, i.e. in every 5 second timeslot, by the Rule 607 which has priority=high, and interval=1. To illustrate the need for user programming, these rules will be different for boats requiring a greater or lesser minimum depth for safe navigation.

The reading instructions 602 enclosed in a second dashed box define the readings “DepthFeet” 608 and BoatSpeedKnots” 609 by specifying the name of the reading, the data message name, the location of the data and the precision with which the reading value is to be stored. These values of these readings are processed by the rules described above.

This application illustrates the flexibility of the system. Different boats often have different configurations of marine instruments and sensors installed for which the data output is in accordance with the NMEA 0183 protocol. The user therefore selects the message parser 220 for this protocol. The UPMS readings can be edited or re-programmed by the users to suit the particular set of sensors on each boat. On each boat, different use cases for the UPMS, requiring different rule-sets, may also be created by the user to assist them in different operations. As illustrated in the examples of FIG. 6, the reading instructions and rules are constructed in normal language and are easy to follow and understand. The simple structure of the Readings and Rules allows them to be created and edited using a GUI 202 as described above and illustrated in FIG. 3. It is therefore possible for the end user to create different readings and rule-sets without any knowledge of computer programming. This makes it possible to use a single apparatus in a wide number of specialized applications. While it is necessary to have knowledge of the structure of the data output by a sensor to construct the reading instructions, this is normally either published by the sensor manufacturer or in the supported protocol documentation, and thus readily available to the end user.

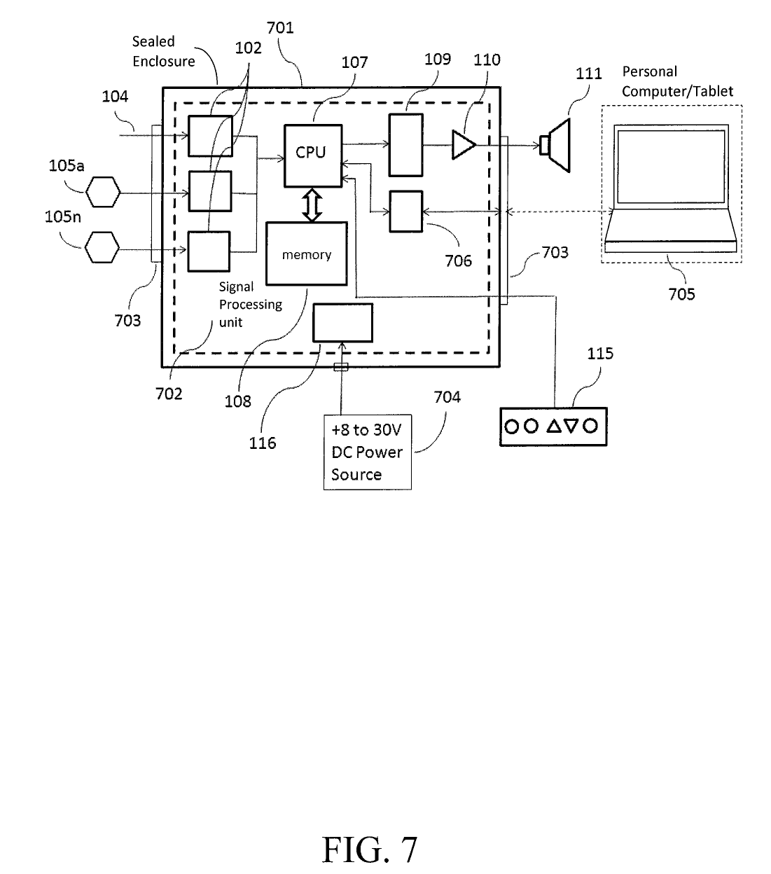

The apparatus used to implement the UPMS 101 may be partitioned in a number of alternative ways that have different advantages. In an embodiment the hardware and firmware used to program or configure the UMPS is separated from the signal processing unit that creates the voice messages and only connected when it is necessary to re-program the system, for example to update or add a new a use-case. Once programmed, the signal processing unit can read sensor data and create voice messages in accordance to the programmed readings, rules and voice files without being connected to the GUI. This embodiment is illustrated in FIG. 7 and allows the size, power consumption and cost of the signal processing unit to be minimized. Because it requires no keyboard or display and has small power requirements, the signal processing unit may then be battery powered and more easily packaged in a sealed waterproof enclosure 701 suitable for operation in non-weather-protected environments such as the cockpit of a boat, or on outdoor construction equipment such as a crane or concrete pump.

The signal processing unit, 702 is shown as a dashed line inside the enclosure 701. The signal processing unit 702 comprises, embedded, the CPU 107, which executes the pre-programmed rules and readings, memory 108 and audio decoder 109 and amplifier 110 and the one or more data ports 102. The components of the signal processing unit 702 may be mounted on a printed wiring board inside enclosure 701. Weatherproof connectors 703 are used to connect the cables carrying signals from the enclosure to external equipment including the data bus 104, instruments 105a . . . 105n, loudspeaker 111 and control panel 115 (see FIG. 1). Alternatively, the control panel 115 and speaker 111 may be built into the waterproof enclosure 701. The complete system is powered from an external DC power source 704 with a wide voltage range that is compatible with vehicular, marine and industrial power supplies. This is converted to the voltages required by the internal electronics by the power converter 116 (FIG. 1) mounted on the PWB 702.

The signal processing unit is programmed by the user by first connecting a separate standard computer 705, which incorporates display 118 and keyboard 117, such as a laptop or tablet computer, to the waterproof unit 701 via an external connector 703. The external computer is thus connected to the embedded processor via a programming port 706, which may, for example, be a USB or Ethernet port, or a Wireless connection such as BlueTooth or Wi-Fi. The external computer 705 provides a keyboard and display, and has the processing and memory resources necessary to implement the Graphical User Interface 202. In this embodiment, the resource-intensive GUI 202 and associated editing and data entry programs are implemented as a separate program running on the processor(s) of the external computer 705. The GUI may be implemented as a special application running on the external PC or on a series of web pages accessed through a standard web browser.

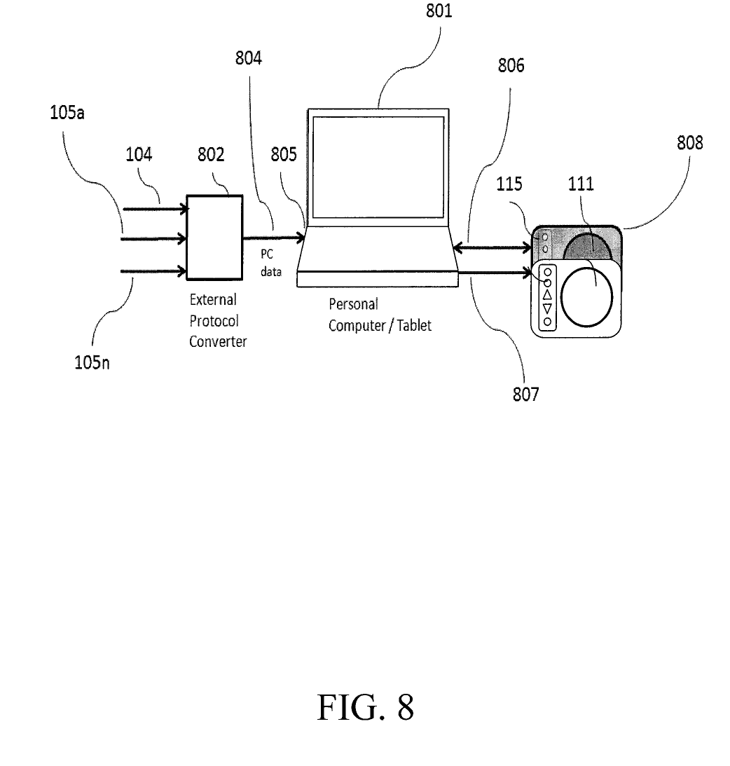

In the embodiment described above, the embedded CPU 107 only has to provide the resources to support the operation of the signal processing unit. In an alternative embodiment shown in FIG. 8, the UPMS 101 may be entirely implemented on a single, more powerful processing platform, such as a personal computer or tablet 810. This configuration may be preferably used when the apparatus is used in a location protected from the weather. An external protocol converter 802 is used to convert the signals from one or more data bus 104 or instrument outputs 105a . . . 105n to a data format 804 compatible with a standard PC interface 805. Commonly available interfaces include a USB port, Ethernet port and Bluetooth or Wi-Fi wireless ports. The protocol converter may either multiplex the data from different sensors onto a single data stream, or provide separate logical channels for each input, preferably using a single physical connection. The user controls 115 may similarly be connected to a standard PC via a second standard interface 806. The PC headphone output 807 is used to provide the audio output to an external audio amplifier and loudspeaker 111. The user controls 115 and loudspeaker 111 are co-located in a separate waterproof housing 808 in order to be useable in outdoor locations. This arrangement of the loudspeaker and control panel may also be used in the preceding embodiment. The external speaker 111 and control panel 115 may be connected to PC 801 via cables 806 and 807 or alternatively via a wireless link.

In this embodiment the computer 801 contains various components of the embodiment of FIG. 1, including one or more CPUs 107, a memory 108 and a decoder 109 required to implement the sensor monitoring function, as well as keyboard 117 and display 118 required for programming the UPMS. The processor and memory provided in the computer must be capable of supporting the user interface as well as the real-time data processing required to output voice messages. The hardware cost and power consumption are therefore higher than required for normal operation in the embodiment shown in FIG. 7.

It is envisaged that, rather than converting the reading to text and then using a text-to-speech converter, the reading could be converted directly into a voice message.

It will be appreciated from the foregoing description that systems, methods or apparatus embodying the present invention can be easily programmed for a variety of different applications and are therefore cost effective for use where the market size for any one of these applications is small and does not justify the cost of developing a single purpose system.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure, and such modifications are intended to fall within the appended claims.

1. A system for providing voice messages based on data input from one or more sensors or instruments, comprising:
a user interface which allows the user to program the system with at least one sensor data reading and one rule that determines the content and timing of at least one voice message based on the data reading value;
a signal processing unit which:
parses the sensor data to extract the readings and executes the rules to create the voice messages;
schedules voice messages for output in defined time-slots, based on a priority programmed by the user, and
decodes voice message for output to an audio output device.

2. The system of claim 1, wherein the user interface is a graphical user interface.

3. The system of claim 1, wherein separate sensors are combined onto a single data bus before being input to the signal processing unit.

4. The system of claim 3 wherein the signal processing unit polls the sensors to generate the data input via the data bus.

5. The system of claim 1, wherein the audio output is connected to a loudspeaker, wireless headset, intercom system, or short range or long range radio network.

6. The system of claim 1, wherein the voice messages are assembled from a library of pre-recorded message segments input or created by the user via the user interface.

7. The system of claim 1, wherein the voice messages are created by a text to speech converter.

8. The system of claim 1, further comprising a simulator for verifying the operation of user-programmed readings and rules can be verified by means of a simulator.

9. A method of monitoring one of more sensors or instruments that provide notifications in the form of data corresponding to voice messages comprising:
converting the sensor data to a format readable by a computing device;
processing the sensor data to create a set of readings pre-programmed by the user;
processing the readings with a set of rules to generate audio messages based on the reading values;
broadcasting the audio messages to alert users to the status of the particular sensor outputs or other parameters derived from the sensor data according to the rules.

10. The method of claim 9, further comprising providing means for the user to create and edit a set of readings which determine the sensor data to be monitored.

11. The method of claim 9, further comprising providing means for the user to create sets of rules for particular applications that determine the content and timing of the voice messages.

12. The method of claim 9, further comprising providing means by which the end user is able to create and edit a library of voice recordings.

13. The method of claim 9, further comprising outputting a voice message composed from a number of separate voice message segments.

14. The method of claim 9, further comprising processing the readings with a set of rules to generate voice message segments in the form of text and then using a text-to-speech converter to convert said text into human speech in a desired language.

15. The method of claim 9, further comprising testing the performance of a rule-set by reading back a log file to simulate the input data.

16. A user-programmable monitoring apparatus for providing voice messages based on data input from sensors or instruments, comprising:
a computing device having a signal processing unit and a graphical user interface that enables the user to create a set of readings, rules and voice recordings that determine the content and timing of the voice messages;
a protocol converter which combines data from at least one of the sensors into a serial data stream readable by the signal processing unit;
the signal processing unit operating on the sensor data to create voice messages based on the sensor data for output to an audio output device.

17. The apparatus of claim 16, wherein the signal processing unit further comprises:
a reading engine which parses the sensor data to extract the readings defined by the user;
a rule engine which executes the rules defined by the user to create the voice messages; and
a scheduler which outputs voice messages in time-slots of fixed duration based on their priority.

18. The apparatus of claim 16, wherein the signal processing unit is implemented using a processor, a memory storage device, an audio decoder and control interfaces.

19. The apparatus of claim 16, wherein the processor, memory storage device, audio decoder and control interfaces are components of a personal or tablet computer.

20. The apparatus of claim 16, wherein the user interface includes an input editor, an error checking function, a rule simulator, a dashboard, a means of creating voice recordings and file-naming utility.

21. The apparatus of claim 16, wherein the user interface is only connected to the signal processing unit when it is necessary to change the readings or rules.

22. The apparatus of claim 16, wherein a library of voice message segments is used to construct each output voice message.

23. The apparatus of claim 16, wherein a text-to-speech converter is used to synthesize voice messages from text strings output by the rule engine.
